(19) United States
(12) Patent Application Publication
(10) Pub. No.: US 2024/0066454 A1
(43) Pub. Date: Feb. 29, 2024

(54) Device and Method for Detecting State of an N95 Air Filter

(71) Applicants: Xing Li, Calgary (CA); Xing Geng, Maple Ridge (CA)

(72) Inventors: Xing Li, Calgary (CA); Xing Geng, Maple Ridge (CA)

(73) Assignee: Xing Li, Calgary, AB (CA)

(21) Appl. No.: 18/480,596

(22) Filed: Oct. 4, 2023

Related U.S. Application Data
(60) Provisional application No. 63/413,000, filed on Oct. 4, 2022.

(30) Foreign Application Priority Data
Aug. 25, 2022 (CN) CN 18391908U

(51) Int. Cl. B01D 46/00; A41D 13/11; H04W 4/80

(52) U.S. Cl. CPC B01D 46/0086; A41D 13/11; H04W 4/80

(57) ABSTRACT

An N95 mask air filter state detection device. The device can be integrated or attached to the N95 mask and includes an electrical sensor coupled to the air filter. The sensor detects static electrical or charge levels of the air filter and provides the electrical level values to a single chip microcomputer. The microcomputer, upon detecting values less than a preconfigured threshold, provides a signal to an LED to illuminate, to a buzzer to play an alert, and/or to a remote paired electronic device. The visual and audible alerts indicate the need to change the filter and thus prevent individuals from using non-functional masks. The alerts also prevent individuals from throwing away functional masks as non-emitting LED and silent buzzer indicate functional filter.

### CROSS-REFERENCE TO RELATED APPLICATION

The present application claims priority to, and the benefit of, Chinese Patent Application No. CN 18391908U, which was filed on Aug. 25, 2022, and U.S. Provisional Application No. 63/413,000, which was filed on Oct. 4, 2022, both of which are incorporated herein by reference in their entirety.

### FIELD OF THE INVENTION

The present invention relates generally to the field of an N95 masks and air filters. More specifically, the present invention relates to a novel method and device for detecting the state of an air filter for N95 face masks. The device is attached to a mask and includes an electrical sensor for detecting static electrical levels of the air filter to determine when the filter is required to be changed. A single chip microcomputer activates an LED and a buzzer, and sends a notification to a paired device when the detected static electrical level is less than a preconfigured threshold wherein the threshold indicates minimum safe value for an effective and safe N95 air filter. By way of background, all current N95 masks or respirators rely on electrostatics to achieve the effect of filtering out 95% of airborne particles that are 0.3 microns. That is, without electrostatics, the fiber of a mask or respirator normally will be effective only for 4+ micron-particles. That is why electrostatic charge technology is so critical to the production of N95 masks and respirators. Accordingly, the present disclosure makes specific reference thereto. Nonetheless, it is to be appreciated that aspects of the present invention are also equally applicable to other like applications, devices, and methods of manufacture.

### BACKGROUND

By way of background, N95 masks and respirators provide a high level of respiratory protection by filtering out airborne particles. The particles can include various types of particulate matter, such as dust, fumes, mist, aerosols, and smoke particulates. Additionally, N95 masks are effective at capturing biological particles like pollen, mold spores, bacteria, viruses, allergens, and more. In fact, the name “N95” originates from the National Institute for Occupational Safety and Health (NIOSH) rating system. The “N” stands for “Not resistant to oil,” indicating that N95 masks are not designed to protect against oily particles, while the “95” indicates that the mask must filter out at least 95% of airborne particles that are 0.3 microns or larger in size.

However, over time, the filter material in N95 masks becomes clogged, thus reducing the effectiveness of the filter material in filtering out particles. Further, individuals wearing the N95 masks are not able to visually determine the efficiency of the filter and whether the filter is still working optimally or if the filter has degraded. Due to lack of means for determination of the filter quality, some individuals may choose to replace their N95 masks before the filter is fully used or deteriorated. This not only results in unnecessary mask replacements but also causes more waste generation. Conversely, many individuals may continue using masks with filters that are deteriorated and are not functioning at an adequate level, which poses a risk to their respiratory health. Currently, there is no efficient method for individuals to determine the functional state of an N95 mask's filter for decision making to continue usage of an N95 mask or to change a N95 mask. Individuals desire a simple and accessible system to determine when an N95 mask should be replaced.

Therefore, there exists a long felt need in the art for a device for detecting the state of an air filter of an N95 face mask. There is also a long felt need in the art for a N95 mask filter functionality checking system that can be attached to the mask. Additionally, there is a long felt need in the art for a method for detecting the state of the N95 filter for determining continued use or for determining when to change the N95 filter. Moreover, there is a long felt need in the art for a N95 filter state detection system that identifies static electricity in the filter. Further, there is a long felt need in the art for a N95 filter state detection system that visually and audibly alerts about the state of the filter. Finally, there is a long felt need in the art for N95 mask filter state checking system that prevents individuals from throwing away N95 masks with a functioning filter or wearing masks with a non-functioning filter.

The subject matter disclosed and claimed herein, in one embodiment thereof, comprises a N95 mask air filter state checking device. The device features a static electrical sensor coupled to the N95 air filter via a coupler. The static electrical sensor is configured to detect real-time and continuous static charge of the N95 air filter. A single-chip microcomputer (SCM) for receiving the static charge value from the static electrical sensor. An LED indicator light for emitting light upon receiving an electrical signal from the SCM when the detected static electrical air level or static charge value of the air filter is less than a threshold value and the filter is to be changed. A signal buzzer for producing auditory alerts based on information received from the static electrical sensor and processed by the SCM. A Bluetooth transmitter for transmitting notifications to a paired user device. The mask can be a conventional mask to cover the nose or alternatively can have a head cover and the N95 filter is positioned to protect the wearer from dirt, dust, pollens, microbes, and more.

In this manner, the N95 mask air filter state checking device of the present invention accomplishes all of the forgoing objectives and provides users with a device and method for detecting the state of an air filter of the N95 mask and alerting users about the state and efficiency of the air filter. The device detects static electrical levels of the filter to indicate when the filter is required to be changed. The device and the method prevent individuals from throwing away functional N95 masks and prevent them from wearing non-functional filter masks.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a N95 filter state checking device configured to assess the condition of an N95 air filter in an N95 face covering mask. The device is attached to an N95 mask and further comprises a flexible and skin-friendly neck ring or band designed to be worn around the neck or adhered to one side of the neck. A static electrical sensor coupled to the N95 air filter via a coupler. The static electrical sensor is configured to detect real-time and continuous static electrical air level or static charge values of the air filter, which accumulates static charge as particles are captured from the air. A single-chip microcomputer (SCM) for receiving the static charge values from the static electrical sensor. An LED indicator light attached to or embedded within the SCM, the LED indicator light emits light upon receiving an electrical signal from the SCM when the detected static electrical air level of the air filter is less than a threshold value. A signal buzzer attached to or embedded within the SCM for producing auditory alerts based on information received from the static electrical sensor and processed by the SCM. A Bluetooth transmitter for transmitting notifications to a paired user device. The air filter is replaceable and positioned within a filter box within the mask, the mask is equipped with an adjustable head fixing strap for secure fit.

In yet another embodiment, a method for detecting filtering state of an N95 air filter is described. The method comprises the steps of attaching or integrating a device for detecting the state of an air filter for an N95 face covering mask. The device includes an electrical sensor, a single chip microcomputer, a signal LED, a signal buzzer, and a Bluetooth or Wi-Fi transmitter. Detecting static charge of the N95 filter by the electrical sensor, sending the detected static charge value to the single chip microcomputer, activating the LED and buzzer when the detected static charge value is less than a threshold charge value and sending a wireless notification to a paired user device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an N95 mask filter state detection system of the present invention attached to an N95 facemask in accordance with the disclosed architecture;

FIG. 2 illustrates another N95 mask equipped with a second embodiment of the N95 mask filter state detection system of the present invention in accordance with the disclosed architecture;

FIG. 3 illustrates a functional block diagram depicting connection of the SCM with different alert means included in the filter state checking device in accordance with the disclosed architecture; and

FIG. 4 illustrates a flow chart depicting a process of detecting the state of an N95 filter by the N95 air filter state detecting device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a device for detecting the state of an air filter of an N95 face mask. There is also a long felt need in the art for a N95 mask filter functionality checking system that can be attached to the mask. Additionally, there is a long felt need in the art for a method for detecting the state of an N95 filter for determining continued use or change of the N95 filter. Moreover, there is a long felt need in the art for a N95 filter state detection system that identifies static electricity in the filter. Further, there is a long felt need in the art for a N95 filter state detection system that visually and audibly alerts about state of the filter. Finally, there is a long felt need in the art for N95 mask filter state checking system that prevents individuals from throwing away N95 masks with a functioning filter or wearing masks with a non-functioning filter.

The present invention, in one exemplary embodiment, is a method for detecting filtering state of an N95 air filter. The method comprises the steps of attaching or integrating a device for detecting the state of an air filter for an N95 face covering mask. The device includes an electrical sensor, a single chip microcomputer, a signal LED, a signal buzzer, and a Bluetooth or Wi-Fi transmitter. Detecting static charge of the N95 filter by the electrical sensor, sending the detected static charge value to the single chip microcomputer, activating the LED and buzzer when the detected static charge value is less than a threshold charge value and sending a wireless notification to a paired user device.

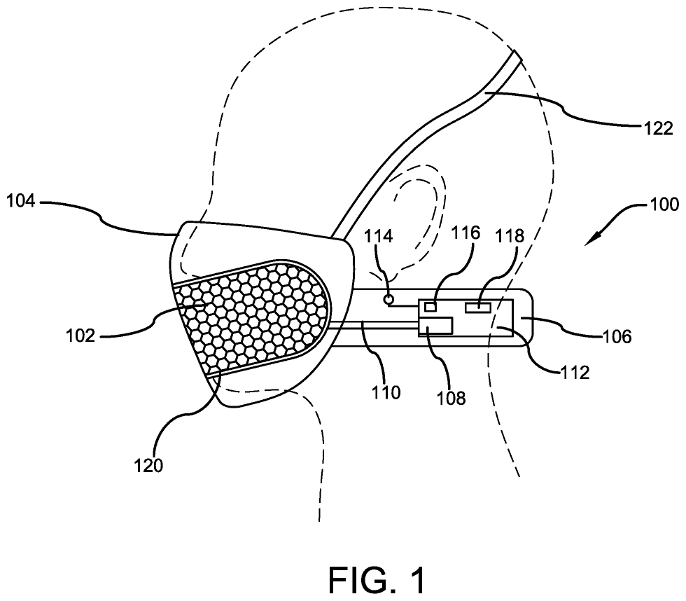

Referring initially to the drawings, FIG. 1 illustrates a perspective view of an N95 mask filter state detection system of the present invention attached to an N95 facemask in accordance with the disclosed architecture. The N95 filter state checking device 100 is designed as a device to assess the condition of the air filter in an N95 face covering mask. More specifically, the device 100 is attached to an N95 filter 102 wherein the N95 filter 102 is equipped in a protective mask 104. The device 100 is housed in a flexible and skin friendly neck ring or band 106. The neck ring or band 106 can be worn around the neck by a wearer or can adhere to one side of the neck in different embodiments of the present invention.

A static electrical sensor 108 is coupled to the N95 filter 102 using a coupler 110 and is configured to detect the static electrical air level or static charge value of the filter 102. The filter 102 accumulates static charge as the filter 102 captures particles from the air and detection of the static electrical air level or static charge value of the filter 102 is done in real time and continuously by the sensor 108 to detect functional state of the filter 102. A single chip microcomputer (SCM) 112 of the device 100 receives the static electrical level of the air filter 102 from the static electrical sensor 108. The SCM 112 is preconfigured with one or more threshold values of static electrical air level of the filter 102 and the received static electrical air level or static charge value is compared to the threshold values.

The SCM 112 is attached to or has embedded an LED indicator light 114 and a signal buzzer 116. The LED indicator light 114 emits light upon receiving an electrical signal from the SCM 112 when the detected static electrical air level of the filter 102 is less than the threshold value. The LED 114 provides a visual notification to a user about the state of the filter 102. In some embodiments, the SCM 112 can control the signal light 114 to change the color, intensity, or blinking pattern depending on the static electrical level detected by the electrical sensor 108. As an example, when the static electrical level of the air filter 102 indicates reduced filter effectiveness, the SCM 112 may instruct the signal light 114 to turn red or flash rapidly to alert the user that the filter needs attention or replacement.

The signal buzzer 116 is an auditory indicator that provides alerts based on the information received from the electrical sensor 108 and processed by the SCM 112. The SCM 112 can control the signal buzzer 116 to produce different patterns of sound such as beeping or buzzing based on the static electrical level detected. A Bluetooth transmitter 118 is used for transmitting a notification to a paired user device such as a smartphone, smartwatch, computer, and the like. The transmitter 118 allows a user to know the state of the filter 102 even when the facemask 104 is not worn by the user. The Bluetooth transmitter 118 transmits a notification when the static electrical level of the air filter 102 indicates reduced filter effectiveness.

The N95 filter 102 is replaceable and can be interchanged in some embodiments as per design of the mask 104. Further, filter 102 is positioned in a filter box 120 which provides a space for accommodating the filter 102 without sliding or any movement. In the present embodiment, the mask 102 has a head fixing strap 122 which is adjustable and provides a snug fit for wearing the mask 104 and the device 100. Further, the mask 104 covers the nose and extends below the chin of the wearer for providing an effective protection.

In the preferred embodiment, the device 100 is designed to be attached to the N95 mask, likely on the side of the user's head. The placement allows for direct monitoring of the air filter's condition while the mask is being worn by the user. It will be apparent to a person skilled in the art that the device 100 addresses the challenge of assessing the filter's functionality and providing users with timely information about the state of their N95 mask's air filter.

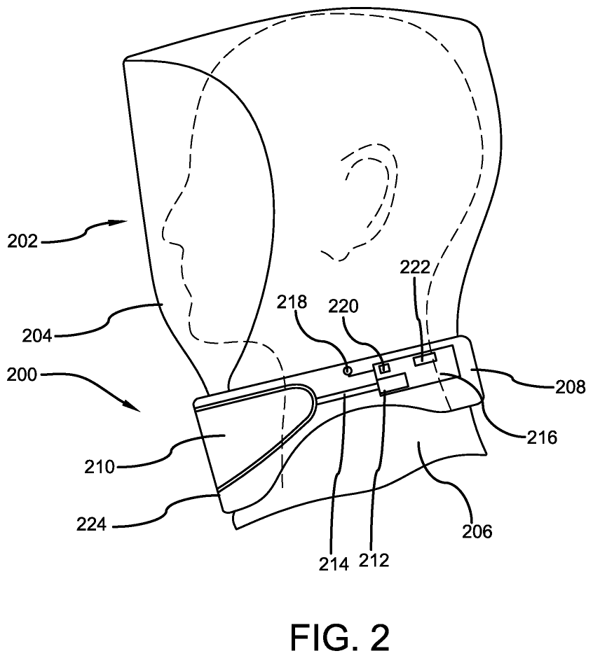

FIG. 2 illustrates another N95 mask equipped with a second embodiment of the N95 mask filter state detection system of the present invention in accordance with the disclosed architecture. In the present embodiment, the filter state checking device 200 can be integrated or detachably attached to the mask 202. More specifically, the mask 202 includes a head cover 204 to cover head of a wearer. The mask 202 is breathable and prevents sweating and extends till skirt edge 206.

The device 200 includes a shoulder ring 208 configured to be worn around the neck or shoulder by the wearer. A N95 filter 210 is coupled to a static electrical sensor 212 using a coupler 214 and the static electrical sensor 212 measures static electrical air level of the filter 210. Like the earlier embodiment, a SCM 216 instructs the LED 218 and the buzzer 220 when the static electrical air level of the filter 210 is less than a threshold value. In the present embodiment, a Wi-Fi transmitter 222 is included in the device 200 that allows transmission of notification to remote devices when the efficiency of the filter 210 is reduced below a threshold level. The filter 210 is stored in the filter box 224 and can be replaced with a new filter when desired by a user.

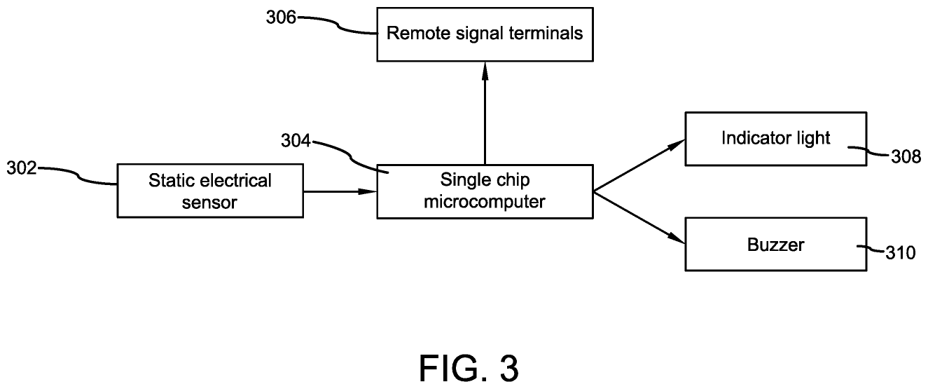

FIG. 3 illustrates a functional block diagram depicting connection of the SCM with different alert means included in the filter state checking device in accordance with the disclosed architecture. As illustrated, the static electrical detection of the filter is transmitted from the static electrical sensor 302 to the single chip microcomputer 304. The electric sensor 302 can be any of the sensor 108, 212 used in other embodiments and the microcomputer 304 can be the SCM 112, 216. When the static electrical value received from the sensor 302 is less than a threshold value then the SCM 304 sends signals in real-time and simultaneously to remote signal terminals 306 such as smartphone, computer, and the like, indicator light 308 and buzzer 310.

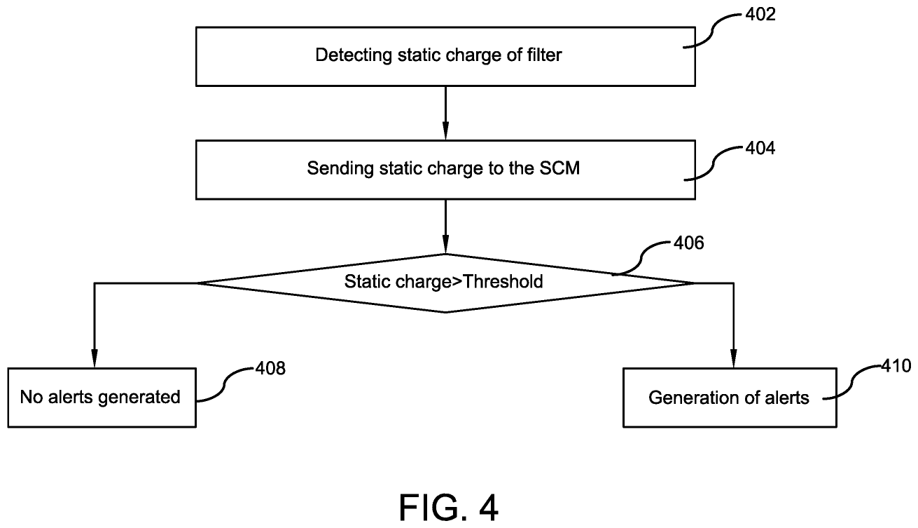

FIG. 4 illustrates a flow chart depicting a process of detecting the state of an N95 filter by the N95 air filter state detecting device of the present invention in accordance with the disclosed structure. Initially, static charge of the N95 air filter is detected by the electrical sensor (Step 402). Then, the detected static charge is converted into a signal and is sent to the single chip microcomputer (Step 404). Thereafter, the microcomputer compares the received static charge value with a threshold charge value (Step 406). If it is determined that the received static charge value is greater than the threshold charge value, then, no alerts are generated by the device (Step 408). In situations when the received static charge value is less than the threshold charge value, alerts are generated in the form of a visual and an audible alert along with a notification on a remote device (Step 410).

In some embodiments, the microcomputer may provide an alert when the received static charge value is slightly more (such as 5% more) than the threshold charge value, to indicate about the upcoming non-functional state of the N95 air filter.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “N95 mask filter state detection system”, “N95 mask air filter state checking device”, “N95 filter state checking device”, “N95 mask filter state detection system”, and “device” are interchangeable and refer to the N95 filter efficiency detection system 100, 200 of the present invention.

Notwithstanding the forgoing, the N95 filter efficiency detection system 100, 200 of the present invention can be of any suitable size and configuration as is known in the art without affecting the overall concept of the invention, provided that it accomplishes the above stated objectives. One of ordinary skill in the art will appreciate that the N95 filter efficiency detection system 100, 200 as shown in the FIGS. 1-2 are for illustrative purposes only, and that many other sizes and shapes of the N95 filter efficiency detection system 100, 200 are well within the scope of the present disclosure. Although the dimensions of the N95 filter efficiency detection system 100, 200 are important design parameters for user convenience, the N95 filter efficiency detection system 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An N95 mask filter state detection system comprising:
an attachment for an N95 face covering mask having a filter state checking device including a mounting, a filter, and a static electrical sensor;
wherein said mounting attaches said filter state checking device proximal to the N95 face covering mask;
wherein said static electrical sensor coupled to said filter of the N95 face covering mask for detecting a static electrical air level of said filter, wherein said filter accumulates static charge as said filter captures particles from the air; and
further wherein said detection of the static electrical air level of said filter is continuous and real time.

2. The mask filter state detection system of claim 1, wherein said static electrical sensor having a single chip microcomputer (SCM) for receiving the static electrical air level of said filter from said static electrical sensor.

3. The mask filter state detection system of claim 2, wherein said SCM having at least one threshold value of the static electrical air level of said filter, and further wherein the received static electrical air level is compared to said threshold value.

4. The mask filter state detection system of claim 3, wherein said SCM having an LED indicator light, and further wherein said LED indicator light emitting a light upon receiving an electrical signal from said SCM when the received static electrical air level of said filter is less than said threshold value.

5. The mask filter state detection system of claim 4, wherein said LED indicator light having a control signal light for changing at least one of a color, an intensity, and a blinking pattern of said control signal light dependent upon the received static electrical air level detected by said static electrical sensor.

6. The mask filter state detection system of claim 5, wherein the changing of said control signal light when the received static electrical air level of said filter is less than said threshold value.

7. The mask filter state detection system of claim 1, wherein said mounting having a flexible neck band for wearing around the neck of the wearer of the N95 face covering mask.

8. The mask filter state detection system of claim 3, wherein said SCM having a signal buzzer including an auditory indicator when the received static electrical air level of said filter is less than said threshold value.

9. The mask filter state detection system of claim 3, wherein said SCM having a Bluetooth transmitter for transmitting a notification to a paired user device when the received static electrical air level of said filter is less than said threshold value.

10. The mask filter state detection system of claim 9, wherein said user device is selected from the group consisting of a smartphone, a smartwatch, and a computer.

11. The mask filter state detection system of claim 1, wherein said filter is replaceable.

12. An N95 mask filter state detection system comprising:
an attachment for an N95 face covering mask having a filter state checking device including a mounting, a filter, and a static electrical sensor;
wherein said mounting attaches said filter state checking device proximal to the N95 face covering mask;
wherein said static electrical sensor coupled to said filter of the N95 face covering mask for detecting a static electrical air level of said filter, wherein said filter accumulates static charge as said filter captures particles from the air; and
further wherein said filter state checking device is detachably attached to the N95 face covering mask.

13. The mask filter state detection system of claim 12, wherein said static electrical sensor having a single chip microcomputer (SCM) for receiving the static electrical air level of said filter from said static electrical sensor.

14. The mask filter state detection system of claim 13, wherein said SCM having at least one threshold value of the static electrical air level of said filter, and further wherein the received static electrical air level is compared to said threshold value.

15. The mask filter state detection system of claim 14, wherein said SCM having an LED indicator light, and further wherein said LED indicator light emitting a light upon receiving an electrical signal from said SCM when the received static electrical air level of said filter is less than said threshold value.

16. The mask filter state detection system of claim 15, wherein said LED indicator light having a control signal light for changing at least one of a color, an intensity, and a blinking pattern of said control signal light dependent upon the received static electrical air level detected by said static electrical sensor.

17. The mask filter state detection system of claim 16, wherein the changing of said control signal light when the received static electrical air level of said filter is less than said threshold value.

18. An N95 mask filter state detection system comprising:
an attachment for an N95 face covering mask having a filter state checking device including a mounting, a filter, and a static electrical sensor;
wherein said mounting attaches said filter state checking device proximal to the N95 face covering mask;
wherein said static electrical sensor coupled to said filter of the N95 face covering mask for detecting a static electrical air level of said filter, wherein said filter accumulates static charge as said filter captures particles from the air;
wherein said filter state checking device is detachably attached to the N95 face covering mask; and
further wherein said mounting having a flexible neck band for wearing around the neck of the wearer of the N95 face covering mask.

19. The mask filter state detection system of claim 18, wherein said static electrical sensor having a single chip microcomputer (SCM) for receiving the static electrical air level of said filter from said static electrical sensor.

20. The mask filter state detection system of claim 19, wherein said SCM having at least one threshold value of the static electrical air level of said filter, and further wherein the received static electrical air level is compared to said threshold value.
